(19) United States
(12) Patent Application Publication
(10) Pub. No.: US 2004/0112099 A1
(43) Pub. Date: Jun. 17, 2004

(54) Key receptacle

(76) Inventor: Mark Randall, Encinitas, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/319,103

(22) Filed: Dec. 12, 2002

(51) Int. Cl. E05B 65/48; E05B 65/52

(52) U.S. Cl. 70/63

(57) ABSTRACT

The following disclosure relates to a key receptacle that can be removably attached to a surface, including a vehicle. The key receptacle can include an enclosure, a door, a locking mechanism for locking and unlocking the door, and a fastener that secures the key receptacle to the surface by way of an aperture in the enclosure. The fastener can be positioned so that it is inaccessible when the door is locked, allowing it to be accessed only by authorized users.

The fastener of the key receptacle can be further configured to communicate with the electrical system of the vehicle to which is attached, and, thus, can act as a kill switch for the vehicle if the integrity of the fastener is comprised. Moreover, the locking mechanism of the key receptacle can be configured to communicate with the locking system of the vehicle to which it is attached, allowing a user to unlock or lock the vehicle by way of the locking mechanism.

### BACKGROUND

The following disclosure relates to a key receptacle that can be removably attached, for example, to the surface of a vehicle or other mounting surface.

FIG. 1 depicts a conventional key lock box 100 for permanent attachment to a vehicle surface, such as a vehicle frame or wheel well, or a tow hitch or trailer tongue. The permanent lock box 100 has a detachable cover 110, having a push button lock mechanism 120, which can be locked to securely enclose the contents of the box. The lock box 100 is permanently attached to the vehicle by four self-tapping screws that bore into the mounting surface.

FIG. 2 depicts another conventional vehicle lock box 200 for temporary attachment to a vehicle, such as on one of its windows. The lock box 200 has a steel hanger 210 that facilitates the temporary attachment. Specifically, while the window is retracted, the steel hanger 210 is positioned over the open edge of the window, the window is then rolled up shut, and the vehicle door is shut or locked. Similarly, to remove the lock box 200, the vehicle door is opened, the window is rolled down, and the steel hanger 210 is removed from the open edge of the window. The side of the steel hanger 210 adjacent to the window typically has a plastic or rubber cover to prevent the steel hanger 210 from scratching the window.

### SUMMARY

The key receptacle described here may have various combinations of the following features: an enclosure, a door, a locking mechanism for locking and unlocking the door, and a fastener, accessible only when the door is unlocked, that secures the key receptacle to the surface by way of an aperture in the enclosure. The fastener can be further configured to communicate with the electrical system of the vehicle and to cut-off the vehicle's power should the integrity of the fastener be comprised. Moreover, the locking mechanism can be configured to communicate with the locking system of the vehicle to which it is attached, allowing for a user to unlock or lock the vehicle by way of the locking mechanism.

The secured key receptacle disclosed has many advantageous features. For instance, a fastener allows the receptacle to be quickly and easily mounted to any surface of a vehicle that has a male prong, such a threaded bolt, or a female receiving end, such as one of the four threaded female acceptors incorporated into the bumper area or license plate frame of a vehicle, used for attaching a license plate. As a result, the receptacle is easily accessible, yet discrete, and can be attached temporarily, semi-permanently or permanently to the vehicle.

Another potential advantage of the receptacle is that the mechanism for fastening it to the mounting surface is accessible only when the receptacle door is unlocked. As a result, only those persons able to unlock the receptacle will be able to detach the receptacle from its mounting surface by way of the fastening mechanism.

Another potential advantage of the receptacle is that it can be proximately located and can be configured to communicate with the vehicle's power source. Consequently, if the receptacle is removed or tampered with, the vehicle's power source can be cut off, leaving the vehicle immobile. Furthermore, should such power source cut-off occur, a mechanism configured to restore the vehicle's power can be discretely positioned elsewhere on the vehicle.

A further potential advantage of the receptacle is that its locking mechanism can be configured to communicate with the vehicle's locking system and to lock and unlock both the receptacle and the vehicle to which it is mounted.

The features of the receptacle tend to make it extremely useful to casual users, as well as to business owners. For instance, a person can park his vehicle, attach the receptacle (if not already mounted) and securely store the vehicle's keys in the receptacle while he goes for a run, walk or hike. Similarly, rental and fleet car businesses can use the receptacle on their vehicles to give multiple users immediate access to the vehicle's keys. Both groups of users can further use the receptacle to unlock and lock the vehicle without the keys.

The details of one or more implementations are set forth in the accompanying drawings and the description below. Other features, and advantages will be apparent from the description and drawings, and from the claims.

### DESCRIPTION OF DRAWINGS

FIG. 1. Shows a conventional lock box for permanent attachment to a vehicle.

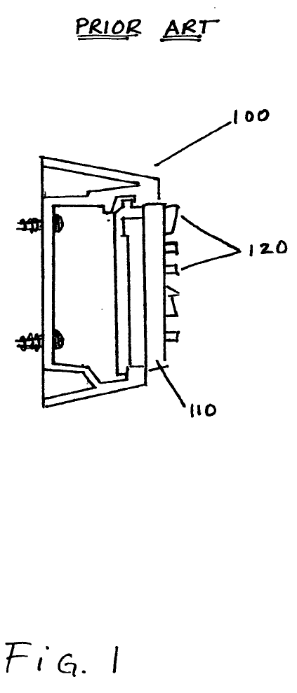

FIG. 2. Shows a conventional lock box for temporary attachment to a vehicle.

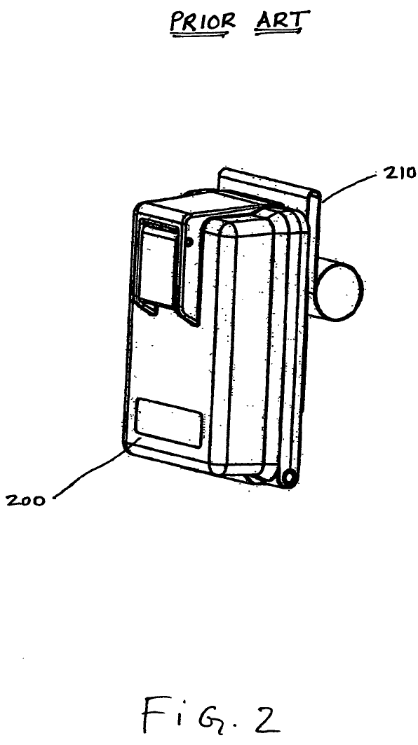

FIG. 3. Shows a secured key receptacle while in its opened position.

FIG. 4. Shows a cross-sectional view of the secured key receptacle of FIG. 3 and its fastener.

FIG. 5. Shows the secured key receptacle of FIG. 3 while attached to vehicle license plate frame.

Like reference symbols in the various drawings indicate like elements.

### DETAILED DESCRIPTION

The secured key receptacle 10 is a device for storing keys or other valuables that may be attached to a surface, such as a vehicle bumper or license plate frame. The receptacle 10 is designed to attach to and detach from the surface quickly and easily, allowing the receptacle 10 to have varying degrees of mounted attachment, such as permanent, semi-permanent or temporary attachment. Despite having a facility for quick and easy detachment, the receptacle 10 is designed to permit only authorized users to detach the receptacle 10 from the mounting surface. The receptacle 10 can also be configured to cut-off a vehicle's power source if tampered with, leaving the vehicle immobile. Moreover, the locking mechanism 18 of the receptacle 10 can be configured to unlock the receptacle 10, as well as the vehicle to which it is attached.

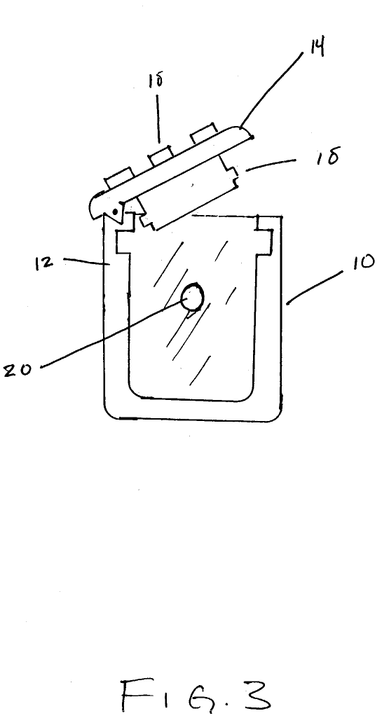

FIG. 3 depicts an implementation of the receptacle 10 while opened and detached from a mounting surface (not illustrated). The receptacle 10 may include several components, including an enclosure 12, a closure or door 14, a fastener 16, a locking mechanism 18, and an aperture 20.

The enclosure 12 of FIG. 3 is designed to securely hold keys or other desired contents within its interior compartment. The enclosure 12 can be shaped like a box, rectangle, sphere, tube, or virtually any other shape that allows the enclosure 12 to be securely locked shut while holding the keys or desired contents. The enclosure 12 can be made of any tamper resistant material, including metal, steel, titanium, or reinforced plastic, rubber or any combination thereof.

The enclosure 12 has a door 14 or other closure for accessing the interior compartment. The door 14 can be removably attached to the enclosure 12. Alternatively, the door 14 can be permanently attached to the enclosure 12 by hinges or the like, as shown in FIG. 3. The door 14 can be locked and unlocked by a locking mechanism 18, such as a simple combination lock or mechanical keypad lock. The lock actuating mechanism 18 could, however, be a more sophisticated device, such as an electrical touch pad, or a fingerprint or bar code scanner.

As depicted in FIG. 3, the enclosure 12 has an aperture 20. The aperture 20 forms a pass-through from the interior of the enclosure 12 to the mounting surface (not shown). As a result, the fastener 16 secures the key receptacle 10 to the mounting surface by way of the aperture 20.

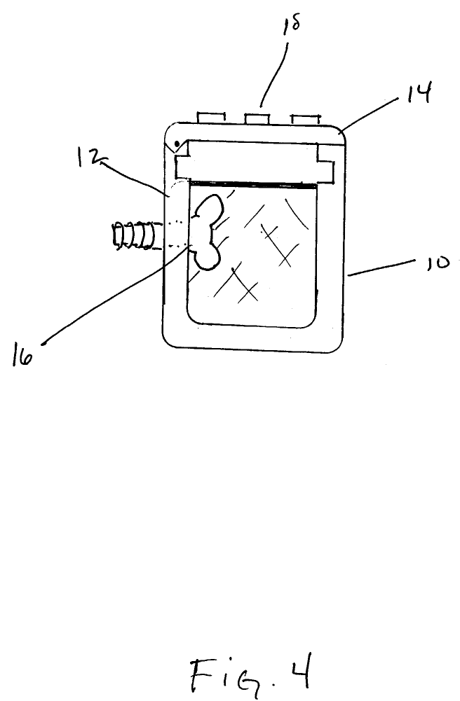

FIG. 4 shows a winged bolt as the fastener 16, but any type of bolt or other similar device, capable of being received by a female acceptor on or in the mounting surface, can also be used. Alternatively, the fastener 16 can be a winged nut or other similar device capable of receiving a male prong incorporated on or in the mounting surface. In fact, whether a person intends to temporarily, permanently, or semi-permanently attach the key receptacle 10 to the vehicle will likely dictate the type of fastener 16 used. For instance, if the key receptacle 10 is to be temporarily attached, it would be preferable to employ a fastener 16 such as a winged bolt or winged nut that can be easily engaged or disengaged using only one's fingers. Alternatively, if the key receptacle 10 is to be semi-permanently or permanently attached, one might instead use as the fastener 16 a ratchet headed bolt or nut, which requires a ratchet tool to fasten and unfasten it.

Because the fastener 16 engages the mounting surface by way of the aperture 20, the fastener 16 can be accessed only when the door 14 is unlocked. Put another way, the fastener 16 is inaccessible when the door 14 is closed and locked shut. As a result, the key receptacle 10 can be attached to or detached from the mounting surface only by authorized persons (e.g., those knowing the lock combination). Consequently, thieves and other unsavory types will be deterred from stealing the receptacle 10 or its contents because to do so would require them either to forcibly remove receptacle 10 from the mounting surface, e.g., by severing the fastener 16, or to break into the receptacle 10 itself.

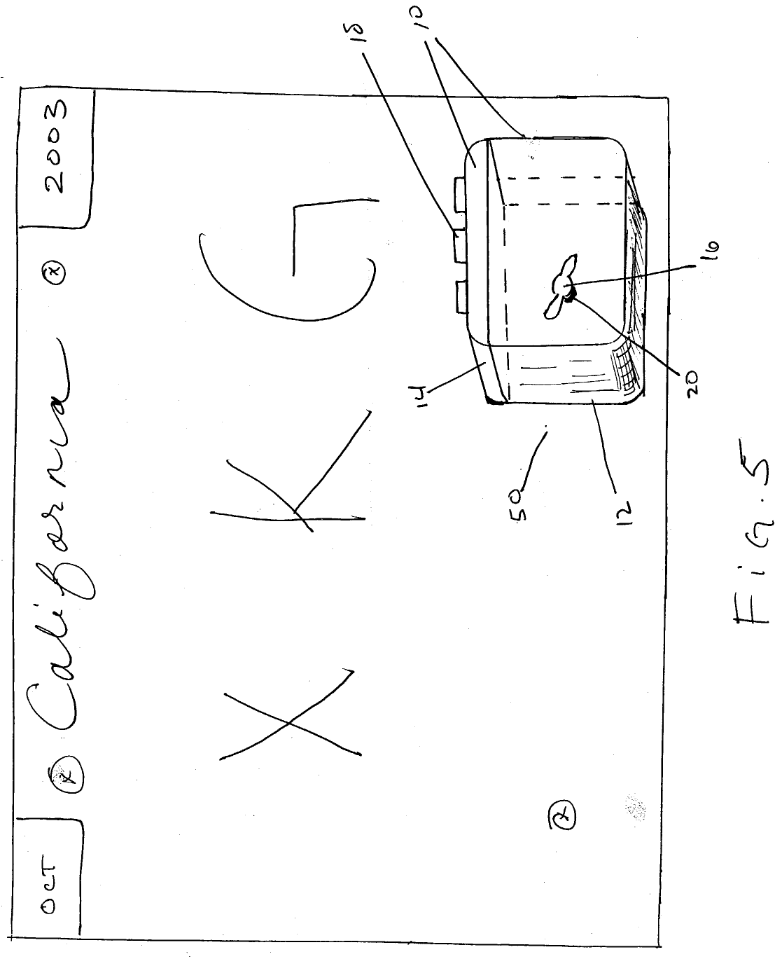

FIG. 5 shows the key receptacle 10 attached to the lower right side of the license plate frame of a vehicle. As shown, the key receptacle 10 sits atop the license plate's surface 50 even though the key receptacle 10 is secured to the license plate frame. To achieve this state, the fastener 16, such as a winged bolt, was passed through the aperture 20 and the preexisting hole of the license plate and was received by the female acceptor in the frame. In this manner, the receptacle 10 can be quickly and easily attached to the vehicle, as a person needs merely to attach the receptacle 10 to one or more of the female acceptors (in this example, four) that are standardly incorporated into the license plate frame or bumper areas of most vehicles. As a result of its design, the receptacle 10 tends to be unobtrusive, e.g., it tends not to obscure writing on the license plate and typically will not affect proper functioning of the vehicle or parts of the vehicle. Furthermore, because the fastener 16 directly engages female acceptors already incorporated into the license plate frame or vehicle bumper, neither the fastener 16 nor the corresponding female acceptor are accessible when the receptacle 10 is closed and locked. This tends to make it very difficult to remove the receptacle 10 without comprising the integrity of the receptacle 10 or the fastener 16.

In another implementation of the secured key receptacle 10, the fastener 16 or other portion of the receptacle 10 can be configured to act as a kill switch. For instance, because the receptacle 10 can be attached to the license plate frame, which is proximately located to the vehicle's power source, the fastener 16 optionally can be configured or communicate (remotely or otherwise) to the vehicle's power source and, if tampered with, cut off the vehicle's power. Thus, if a thief trying to gain access to the key receptacle 10 breaks or otherwise compromises the integrity of the fastener 16, the vehicle's power source will be cut off, thereby preventing the vehicle from being started even if the thief could access the keys in the receptacle. However, even if the power cut-off is engaged, a mechanism to quickly restore the vehicle's power, such as a power override switch, can be discretely situated in another area of the vehicle.

In yet another implementation of the secured key receptacle 10, the lock actuating mechanism 16 can be configured or programmed to unlock the vehicle. In such an implementation, the receptacle 10 can be configured to communicate (remotely or otherwise) to the vehicle's locking system, for instance, by way of the fastener 16 or a remote electronic device incorporated in the receptacle 10. As a result, the lock actuating mechanism 18, such as an electric combination lock, can be configured or programmed to unlock both the vehicle and the receptacle when the correct combination is entered.

The disclosed key receptacle 10 has many practical uses. For example, athletic individuals may find the receptacle particularly useful when they park their car and go for a run, bike or walk on the beach. Depending the frequency with which the individual uses the receptacle 10, the individual can quickly attach and detach the receptacle 10 at each use, or the individual can let the receptacle 10 reside on the vehicle for varying amounts of time, i.e., temporarily, semi-permanently, or permanently, because its non-interfering positioning tends not to hamper normal uses of the vehicle. Similarly, the key receptacle may be useful to businesses, such as rental car or fleet car services, that need to give more than one person quick and easy access to the vehicle's keys. Moreover, the secured appearance of key receptacle 10 (and its fastener 16) will tend to deter potential thieves from attempting to steal the receptacle 10 or its contents.

A number of implementations of the key receptacle 10 have been described. Nevertheless, it will be understood that various modifications may be made. Accordingly, other implementations are within the scope of the following claims.

What is claimed is:

1. A key receptacle for attachment to a surface, comprising:
an enclosure;
a door for accessing the interior of the enclosure;
a locking mechanism for locking and unlocking the door;
an aperture incorporated in the enclosure; and
a fastener for securing the receptacle to the surface by way of the aperture, and
being accessible only when the door is unlocked.

2. The key receptacle of claim 1 wherein the enclosure is made of tamper-resistant material.

3. The key receptacle of claim 2 wherein the enclosure is made of metal, steel, titanium, plastic, polyester, or rubber.

4. The key receptacle of claim 1 wherein the enclosure is shaped of dimensions allowing for an interior compartment within the enclosure.

5. The key receptacle of claim 4 wherein the enclosure is shaped like a box, rectangle, sphere or tube.

6. The key receptacle of claim 1 wherein the door is made of tamper-resistant material.

7. The key receptacle of claim 6 wherein the door is made of metal, steel, titanium, plastic, polyester, or rubber.

8. The key receptacle of claim 1 wherein the door is shaped to configure to the shape of the enclosure.

9. The key receptacle of claim 1 wherein the door, while unlocked, can be detached from the enclosure.

10. The key receptacle of claim 1 wherein the door, while unlocked, is attached to the enclosure.

11. The key receptacle of claim 1 wherein the door is attached to the enclosure by hinges or springs.

12. The key receptacle of claim 1 wherein the locking mechanism is configured to communicate with the locking system of vehicle.

13. The key receptacle of claim 12 wherein the locking mechanism is further configured to allow a user to unlock and lock the vehicle.

14. The key receptacle of claim 1 wherein the locking mechanism is comprised of a keypad, combination, scanner, button, switch, trigger, or lever.

15. The key receptacle of claim 1 wherein the locking mechanism is configured to communicate with the electrical system of a vehicle.

16. The key receptacle of claim 1 wherein the fastener is made of tamper-resistant material.

17. The key receptacle of claim 16 wherein the fastener is made of metal, steel, titanium, plastic, polyester, or rubber.

18. The key receptacle of claim 16 wherein the fastener has a male prong for insertion into a female receiving end.

19. The key receptacle of claim 16 wherein the fastener has a female end for receiving a male prong.

20. The key receptacle of claim 16 wherein the fastener is configured to communicate with the electrical system of a vehicle.

21. The key receptacle of claim 20 wherein the fastener is configured to cut off the electrical power to the vehicle.
